(19) United States
(12) Patent Application Publication
(10) Pub. No.: US 2026/0168126 A1
(43) Pub. Date: Jun. 18, 2026

(54) Method For Detecting Metal Foreign Material In Electrode Active Material

(71) Applicants: LG Energy Solution, Ltd., Seoul (KR); Seoul National University R&DB Foundation, Seoul (KR)

(72) Inventors: A Ra Cho, Daejeon (KR); Sang Woo Kim, Daejeon (KR); Taek Dong Chung, Daejeon (KR); Woo Yeoul Shim, Daejeon (KR); Jung Hye Won, Daejeon (KR); Yeu Young Youn, Daejeon (KR)

(21) Appl. No.: 19/129,453

(22) PCT Filed: Dec. 15, 2023
(86) PCT No.: PCT/KR2023/020778

§ 371 Date: May 13, 2025

(30) Foreign Application Priority Data
Dec. 15, 2022 (KR) 10-2022-0176331
Dec. 14, 2023 (KR) 10-2023-0182194

(51) Int. Cl. C25D 5/18; C25D 3/54; H01M 4/131; H01M 4/505; H01M 4/525; H01M 10/052; H01M 10/0525

(52) U.S. Cl. CPC C25D 5/18; C25D 3/54; H01M 4/131; H01M 4/505; H01M 4/525; H01M 10/052; H01M 10/0525

(57) ABSTRACT

A method for detecting a metal foreign material in an electrode active material includes a first step of dissolving an electrode active material in an aqueous nitric acid solution to form a metal foreign material extraction solution, a second step of plating a metal foreign material in the metal foreign material extraction solution on an electrode, and a third step of measuring an amount of the metal foreign material plated on the electrode.

### CROSS-REFERENCE TO RELATED APPLICATIONS

This application is a national stage entry under 35 U.S.C. § 371 of International Application No. PCT/KR2023/020778 filed on Dec. 15, 2023, which claims priority to Korea Patent Application No. 10-2022-0176331 filed on Dec. 15, 2022, and Korean Patent Application No. 10-2023-0182194 filed on Dec. 14, 2023, the entire disclosures of each of which are incorporated herein by reference in their entirety.

### TECHNICAL FIELD

The present disclosure relates to a method for detecting a metal foreign material in an electrode active material, and more particularly, to a method for detecting a fine metal foreign material smaller than 40 μm, which is hardly removable in advance, and quantitatively analyzing an amount thereof.

### BACKGROUND

Among secondary battery materials, metal foreign materials contained in electrode active materials may be precipitated on a surface of a negative electrode during charging and discharging to form an internal short circuit, which may cause capacity reduction, low voltage failure, and/or fire. Accordingly, for the purpose of managing the quality of secondary batteries, an amount of metal foreign materials in electrode active materials needs to be measured and evaluated.

Accordingly, typically, a method of removing metal foreign materials in electrode active materials using a magnetic separator, or a method of measuring an amount of metal foreign materials in electrode active materials through ICP analysis and managing the amount to be within a certain range has been used. However, these typical methods are incapable of detecting metal foreign materials of small particle size. Specifically, metal foreign materials having a particle size of less than 40 μm are hardly removable in advance using a magnetic separator, and metal foreign materials contained in a low amount of less than 1 ppm are hardly measurable through ICP analysis due to a significant influence of matrix effect caused by electrode active material components.

Accordingly, for the purpose of managing the amount of metal foreign materials in electrode active materials, there is a need to develop a method capable of detecting fine non-magnetic metal foreign materials and quantitatively analyzing the amount thereof.

### SUMMARY

### Technical Problem

In order to address the above-described tasks, an aspect of the present disclosure provides a detection method capable of quantitatively detecting a very small amount of fine metal materials contained in an electrode active material.

### Technical Solution

According to an aspect of the present disclosure, provided is a method for detecting a metal foreign material in an electrode active material, wherein the method includes a first step of dissolving an electrode active material in an aqueous nitric acid solution to form a metal foreign material extraction solution, a second step of plating a metal foreign material in the metal foreign material extraction solution on an electrode, and a third step of measuring an amount of the metal foreign material plated on the electrode.

In this case, the electrode active material may include a metal foreign material having a particle size of 40 μm or less, wherein the metal foreign material may be Cu.

In addition, the electrode active material may be a positive electrode active material, wherein the positive electrode active material may have a D₅₀ of 1 to 40 μm.

Meanwhile, the first step may be performed in the conditions that the metal foreign material has a solubility of 80% or greater and a metal component of the electrode active material has a solubility of 50% or less. Specifically, the first step may be performed by dissolving the electrode active material in an aqueous nitric acid solution having a nitric acid concentration of 20 to 40 wt % and then stirring the resulting product at room temperature for at least 20 hours.

Meanwhile, the second step may be performed by immersing the electrode in the metal foreign material extraction solution and then applying a current to allow a potential difference in which a metal component in the electrode active material is not reduced and the metal foreign material to be extracted is reduced, wherein the electrode may be a carbon electrode.

Thereafter, the third step may be performed by dissolving the metal foreign material plated on the electrode using acid and then measuring an amount of the dissolved metal foreign material through inductively coupled plasma (ICP) or anodic stripping voltammetry.

When the method of ICP is used, the acid may include hydrochloric acid, nitric acid, hydrogen peroxide, or a mixture thereof. For example, the acid may include at least one of hydrochloric acid and nitric acid, or hydrogen peroxide.

### Advantageous Effects

A detection method according to the present disclosure selectively recovers a metal foreign material in an electrode active material using an aqueous nitric acid solution, extracts the metal foreign material from the electrode active material by selectively plating the metal foreign material on an electrode through an electrochemical method, and then measures an amount of the metal foreign material plated on the electrode, and may thus minimize a matrix effect of a metal component in the electrode active material to quantitatively analyze an amount of the metal foreign material having a particle size of 40 μm or less and contained in an amount of less than 1 ppm.

### DETAILED DESCRIPTION

Hereinafter, aspects of the present disclosure will be described in detail.

Through repeated research on managing metal foreign materials in electrode active materials, which influence battery performance and safety, the present inventors have devised a method for selectively recovering a metal foreign material in an electrode active material using an aqueous nitric acid solution, plating the metal foreign material on an electrode and then measuring an amount of the metal foreign material plated on the electrode, and thus minimizing a matrix effect of a metal component in the electrode active material to quantitatively detect an amount of the metal foreign material having a particle size of 40 μm or less and contained in an amount of less than 1 ppm.

Specifically, the method for detecting a metal foreign material in an electrode active material according to the present disclosure includes a first step of dissolving an electrode active material in an aqueous nitric acid solution to form a metal foreign material extraction solution, a second step of plating a metal foreign material in the metal foreign material extraction solution on an electrode, and a third step of measuring an amount of the metal foreign material plated on the electrode.

Hereinafter, the method for detecting a metal foreign material in an electrode active material according to the present disclosure will be described in detail.

### (1) Step 1: Eluting Metal Foreign Material

First, an electrode active material is dissolved in an aqueous nitric acid solution, and a metal foreign material is eluted to form a metal foreign material extraction solution (first step).

In this case, the electrode active material may include a metal foreign material having a particle size of 40 μm or less, and the metal foreign material may be at least one selected from the group consisting of Cu, Zn, Ti, Sn, Pb, and an alloy thereof. For example, the metal foreign material may be Cu.

The electrode active material may be a positive electrode active material or a negative electrode active material. For example, the electrode active material may be a positive electrode active material. Meanwhile, the positive electrode active material may have a D₅₀ of 1 to 40 μm, or 1 to 25 μm.

The first step is to selectively extract metal foreign materials contained in the positive electrode active material and uses an aqueous nitric acid solution as an extraction solvent. Specifically, the first step may be performed by adding an electrode active material to an aqueous nitric acid solution and stirring the resulting product for a certain period of time to allow metal in the electrode active material to elute.

In order to increase the extraction rate of metal foreign material, the first step may be performed in the conditions that the metal foreign material has a solubility of 80% or greater and a metal component that makes up the electrode active material, such as Ni, Co, Mn, or Al (for convenience, referred to as an ‘electrode active material metal component’), has a solubility of 50% or less. The solubility of the metal foreign material and the solubility of the metal component of the electrode active material vary depending on the concentration, elution time, and elution temperature of the nitric acid aqueous solution. Therefore, the solubility of the metal foreign material and the solubility of the metal component of the electrode active material may be regulated by appropriately controlling conditions of the concentration of the nitric acid aqueous solution used according to the type of metal foreign material to be detected, and the metal ion elution.

For example, when the metal foreign material to be detected is copper (Cu), an aqueous nitric acid solution having a nitric acid concentration of 20 to 40 wt % is used. This is because when the nitric acid aqueous solution concentration satisfies the above range, the solubility of copper increases and the solubility of transition metals becomes relatively low, leading to an increase in copper extraction rate.

In addition, when the metal foreign material to be detected is copper (Cu), an electrode active material is dissolved in an aqueous nitric acid solution, and then stirred at room temperature, for example, at 10° C. to 30° C. for at least 1 hour, or for 1 hour to 30 hours to elute the metal foreign material. When the elution temperature and time satisfy the above range, the solubility of copper in the nitric acid aqueous solution increases relative to the metal component of the electrode active material, and thus the copper ratio in the extraction solution may increase.

However, when the type of metal foreign material to be detected varies, the conditions of the concentration of the nitric acid aqueous solution and elution may also vary accordingly.

The metal foreign material in the electrode active material is extracted in the same manner as above, and then the solution containing the metal foreign material is separated through a method such as centrifugation to obtain a metal foreign material extraction solution.

When metal is eluted using the difference between the solubility of the metal component of the electrode active material and the solubility of the metal foreign material as in the present disclosure, an amount of the metal component of the electrode active material to be eluted can be minimized.

Specifically, using the method as described above, the amount of the metal component of the electrode active material contained in the extraction solution may be reduced to a level of one-half to one-third compared to the amount contained in the electrode active material.

### (2) Step 2: Plating

Thereafter, the metal foreign material contained in the metal foreign material extraction solution obtained through the first step is plated on an electrode (second step).

The second step is to selectively extract the metal foreign material from the metal foreign material extraction solution, and, for example, may be performed by immersing an electrode in the metal foreign material extraction solution and applying a current to the electrode. In this case, the current may be applied to have a potential difference such that the metal component of the electrode active material is not reduced, but the metal foreign material to be extracted is reduced, and the electrode may be a carbon electrode. In this case, the potential difference varies according to the type of metal foreign material, and may thus be appropriately regulated according to the type of metal foreign material to be detected.

The metal foreign material extraction solution obtained through the first step contains metal foreign materials and metal components of the electrode active material, such as Ni, Co, or Mn as well. Therefore, in order to accurately measure the amount of the metal foreign material, the metal foreign material to be detected and the metal component of the electrode active material need to be separated.

Therefore, in the present disclosure, a current is applied to the extraction solution in a voltage range at which the metal foreign material to be detected is reduced, and the metal foreign material is reduced and precipitated on an electrode (positive electrode) to form a plating layer, thereby separating the metal foreign material from the extraction solution. When the metal foreign material is separated through electroplating as such, only the metal foreign material is selectively reduced and precipitated in the plating layer to create an environment that is not affected by a matrix effect caused by the metal component of the electrode active material, and accordingly, even a very small amount of the metal foreign material contained at a level of ppb may be quantitatively measured.

### (3) Step 3: Measuring Metal Foreign Material

Thereafter, an amount of the metal foreign material plated on the electrode is measured (third step). In this case, the measurement of the amount of the metal foreign material may be performed, for example, through electrochemical analysis methods such as inductively coupled plasma (ICP) or anodic stripping voltammetry.

In this case, the measurement of the amount of the metal foreign material using inductively coupled plasma (ICP) may be performed by dissolving the metal foreign material plated on the electrode with acid to prepare a sample solution and then measuring the amount of the metal foreign material in the sample solution using an inductively coupled plasma optical emission spectrometer (ICP-OES), an inductively coupled plasma atomic emission spectrometer (ICP-AES), or an inductively coupled plasma mass spectrometer (ICP-MS).

In this case, the acid may include hydrochloric acid, nitric acid, hydrogen peroxide, or a mixture thereof. For example, the acid may include at least one of hydrochloric acid and nitric acid, or hydrogen peroxide.

As described above, only the metal foreign material is selectively reduced and precipitated in the plating layer obtained through the second step, and accordingly, the environment that is not affected by a matrix effect caused by the metal component of the electrode active material is created. Therefore, even the metal foreign material contained in an extremely small amount at the level of ppb may be analyzed through the method of ICP.

Meanwhile, the measurement of the amount of the metal foreign material using the anode stripping voltammetry may be performed by applying a potential difference of opposite polarity to the potential difference applied in the second step to the electrode plated with the metal foreign material to ionize the metal foreign material in the plating layer and measuring an amount of current generated during this process to measure an amount of the metal foreign material.

When the amount of the metal foreign material using the electrochemical methods as described above, the amount may be simply measured without a separate treatment process for measuring the amount.

### EXAMPLES

Hereinafter, aspects of the present disclosure will be described in more detail with reference to specific examples.

### Example 1

50 mL of a 20 wt % aqueous nitric acid solution was added to 10 g of a positive electrode active material (NCM811), stirred at room temperature at 300 rpm for 24 hours, and then centrifuged at 8000 rpm for 10 minutes to prepare a metal foreign material extraction solution A.

8 ml of the metal foreign material extraction solution A was placed in an electrochemical cell, and a three-electrode system provided with a glassy carbon electrode as a working electrode, a silver chloride electrode (Ag/AgCl) as a reference electrode, and a platinum wire (Pt wire) as a counter electrode was prepared.

Then, −0.2 V was applied to the glassy carbon electrode for a total of 120 seconds to plate metal in the metal foreign material extraction solution A. In this case, plating was performed while the solution was stirred at 300 rpm for 60 seconds using a stirrer, and the stirrer was stopped for the remaining 60 seconds to allow the solution to reach equilibrium.

### Example 2

A metal foreign material extraction solution B was prepared and plated in the same process as Example 1, except that 0.11 mg of copper particles were mixed with about 10 g of a positive electrode active material (NCM811).

### Example 3

A metal foreign material extraction solution C was prepared and plated in the same process as Example 1, except that 0.13 mg of copper particles were mixed with about 10 g of a positive electrode active material (NCM811).

### Experimental Example 1

10 g of each of the metal foreign material extraction solutions A to C prepared in Examples 1 to 3 was taken, and then an amount of Cu was measured using ICP-OES equipment. The measurement results are shown in Table 1.

### Experimental Example 2

After plating was completed in Examples 1 to 3, a voltage of 0.3 V was applied to oxidize the metal, and the stripping charge was measured (anodic stripping voltammetry, ASV). The measurement results are shown in table 1 below.

TABLE 1

| | Cu amount (μM) | Stripping charge |
|---|---|---|
| | measured through | (μC) measured |
| | ICP-OES | through ASV |
| Example 1 | Not measurable | 10.2 |
| Example 2 | 29.2 | 20.7 |
| Example 3 | 35.3 | 23.6 |

Table 1 shows that in the metal foreign material extraction solution of Example 1 in which no additional metal foreign material (Cu) was added, the metal foreign material is contained in a very small amount in the positive electrode active material, and thus the amount of the metal foreign material is not measurable using ICP-OES, but quantification is achievable when the measurement is performed using ASV after plating, as in the method of the present disclosure. Meanwhile, in Examples 2 and 3, an additional metal foreign material (Cu) was added to increase the amount of the metal foreign material, and thus the amount of the metal foreign material is measurable using ICP-OES, and as shown in Table 1, it is seen that with the increase in the amount of the metal foreign materials measured through ICP-OES, charges value measured through ASV also rise. This indicates that the charge values measured through ASV may represent the amount of the metal foreign material. Therefore, it is seen that according to the method of the present disclosure, quantifying a very small amount of the metal foreign material that is not measurable through ICP is achievable.

1. A method for detecting a metal foreign material in an electrode active material, the method comprising:
a first step of dissolving an electrode active material in an aqueous nitric acid solution to form a metal foreign material extraction solution;
a second step of plating a metal foreign material in the metal foreign material extraction solution on an electrode; and
a third step of measuring an amount of the metal foreign material plated on the electrode.

2. The method of claim 1, wherein the electrode active material comprises a metal foreign material having a particle size of 40 μm or less.

3. The method of claim 2, wherein the metal foreign material is at least one selected from the group consisting of Cu, Zn, Ti, Sn, Pb, and an alloy thereof.

4. The method of claim 1, wherein the metal foreign material has a solubility of 80% or greater in the metal foreign material extraction solution and a metal component of the electrode active material has a solubility of 50% or less in the metal foreign material extraction solution.

5. The method of claim 1, wherein the aqueous nitric acid solution has a nitric acid concentration of 20 to 40 wt %.

6. The method of claim 1, wherein the first step is performed by dissolving the electrode active material in the aqueous nitric acid solution having a nitric acid concentration of 20 to 40 wt %, and then stirring the resulting product at room temperature for at least 20 hours.

7. The method of claim 1, wherein the second step is performed by immersing the electrode in the metal foreign material extraction solution and then applying a current to allow a potential difference such that a metal component of the electrode active material is not reduced and the metal foreign material to be extracted is reduced.

8. The method of claim 7, wherein the electrode is a carbon electrode.

9. The method of claim 1, wherein the third step is performed by dissolving the metal foreign material plated on the electrode using acid and then measuring an amount of the dissolved metal foreign material through inductively coupled plasma (ICP).

10. The method of claim 9, wherein the acid comprises hydrochloric acid, nitric acid, hydrogen peroxide, or a mixture thereof.

11. The method of claim 9, wherein the acid comprises at least one of hydrochloric acid and nitric acid, or hydrogen peroxide.

12. The method of claim 1, wherein the third step is performed through anodic stripping voltammetry.
